(19) United States
(12) Patent Application Publication
(10) Pub. No.: US 2005/0108750 A1
(43) Pub. Date: May 19, 2005

(54) Candidate data selection and display apparatus and method

(75) Inventors: Yuko Nishikawa, La Jolla, CA (US); Dayan Golden, San Diego, CA (US); Michael A. Bergeron, Poway, CA (US); Himgan Wibisono, San Francisco, CA (US); Philip McKay, San Francisco, CA (US)

Correspondence Address: FITCH EVEN TABIN & FLANNERY, 120 SOUTH LASALLE SUITE 1600, CHICAGO, IL, 60603, US

(73) Assignees: Sony Corporation, a Japanese corporation, Tokyo (JP); Sony Electronics Inc., a Delaware corporation, Park Ridge, NJ (US)

(21) Appl. No.: 10/806,876

(22) Filed: Mar. 23, 2004

Related U.S. Application Data
(60) Provisional application No. 60/520,752, filed on Nov. 17, 2003.

(51) Int. Cl. H04N 5/445; G06F 3/00; H04H 9/00; G06F 13/00; H04N 7/16

(52) U.S. Cl. 725/38; 725/136; 348/469

(57) ABSTRACT

Characterizing descriptor information for a presently viewed program is used to develop selection criteria by which to identify other program choices of potential interest to the viewer. Such options are then displayed to the viewer, either upon command or automatically at a time that is temporally proximal to a conclusion of the presently viewed program.

### PROVISIONAL APPLICATIONS

We claim the benefit of Provisional Patent Application No. 60/520,752, entitled “Ring Interface for TV Programming Guide” and as filed on Nov. 17, 2003.

### RELATED APPLICATIONS

This application relates to each of the following applications, each of which is commonly owned and was filed on an even date herewith and each of which is hereby incorporated by this reference:
3 DIMENSIONAL BROWSING AND SELECTION APPARATUS AND METHOD (attorney's docket number 81231);
INTERACTIVE PROGRAM GUIDE WITH PREFERRED ITEMS LIST APPARATUS AND METHOD (attorney's docket number 81233);
DISPLAY FILTER CRITERIA AND RESULTS DISPLAY APPARATUS AND METHOD (attorney's docket number 81234);
FILTER CRITERIA AND RESULTS DISPLAY APPARATUS AND METHOD (attorney's docket number 81205);
AUTOMATIC CONTENT DISPLAY APPARATUS AND METHOD (attorney's docket number 81232);
MULTI-SOURCE PROGRAMMING GUIDE APPARATUS AND METHOD (attorney's docket number 81235).

### TECHNICAL FIELD

This invention relates generally to information displays and more particularly to the use of selection criteria.

### BACKGROUND

Information displays of various kinds are essentially ubiquitous in modern society. Many such displays serve, at least in part, to present content options to a viewer. As the number, kind, and constitution of such content options expand, a concurrent challenge arises to facilitate a way to navigate such options in a manner that is helpful and meaningful to the viewer.

Interactive programming guides are an example of such challenges. With cable, fiber, and/or satellite broadband services facilitating the delivery of an increasing number of varied programming options at any given time, it becomes more important to present a viewer with useful and helpful interface mechanisms to permit the viewer to be informed regarding available content options as the sheer magnitude of programming options renders unlikely the possibility that the viewer will be otherwise sufficiently knowledgeable in this regard.

Present suggestions regarding interactive programming guides as used with various audio/visual content services often present a number of candidate programming options on a display. In some cases this display will include a short textual description of the content of one or more of the candidate programming options or other static information (such as a rating, a brief listing of key actors, a year of publication, and the like).

Display criteria filters are sometimes used to limit in some predetermined or selectable fashion the particular candidate programming options that are available for display. For example, a viewer may be offered the option to limit the displayable pool of programming options to only those options that are presently available for viewing. While helpful in some instances to facilitate the content selection process, such an approach does not meet the needs of all viewers under all viewing circumstances. For example, filter control often requires navigation of nested setting choices (which are often presented in a series of nested menus). Navigation of such a configuration to locate a desired setting opportunity can be both cumbersome and non-intuitive. Further, the navigation process itself, coupled with the loss of present on-screen data, can permit some viewers to lose their train of thought and hence stymie rather than facilitate the subjective process of selecting viewing material of interest to the viewer. And further yet, presently contemplated filter criteria does not necessarily suit all viewer's needs or circumstances.

### BRIEF DESCRIPTION OF THE DRAWINGS

The above needs are at least partially met through provision of the candidate data selection and display apparatus and method described in the following detailed description, particularly when studied in conjunction with the drawings, wherein:

FIG. 1 comprises a block diagram as configured in accordance with various embodiments of the invention;

FIG. 2 comprises a flow diagram as configured in accordance with various embodiments of the invention;

FIG. 3 comprises a flow diagram as configured in accordance with various embodiments of the invention;

FIG. 4 comprises a display as configured in accordance with various embodiments of the invention; and

FIG. 5 comprises a display as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

Generally speaking, pursuant to these various embodiments, characterizing descriptors as individually correspond to a plurality of discrete selectable items of data are provided. Then, while displaying a presently selected discrete selectable item of date, characterizing descriptors as correspond to that selected item of data are used to provide at least one selection criterion. That selection criterion then serves to facilitate identification of at least another one of the discrete selectable items of data. Depending upon the embodiment, that identified item of data is then automatically displayed or displayed in response to a specific user instruction. When automatically displayed the information can be displayed, in a preferred approach, at a time that is temporally proximal to a conclusion of displaying the presently selected item of data.

In a preferred embodiment the characterizing descriptors comprise any of a variety of descriptors as may be relevant to a variety of audio/visual programs (such as television programs or movies).

So configured, upon nearing, reaching, or having recently reached the conclusion of a presently selected programming option (such as a movie), a viewer can readily access or be otherwise provided with information regarding other programming options that correspond in some favorable way with this program. For example, characterizing descriptors for the selected program may identify the program as belonging to a particular content genre and that features certain specified actors. That information can be used to identify other presently available (or soon to be available) program options that may be of interest to the viewer. In particular, a short list of features that are similar or that otherwise correspond in some appropriate way with a presently viewed program can be provided to a viewer to permit that viewer to continue their viewing activity with another program option of likely present interest to that viewer.

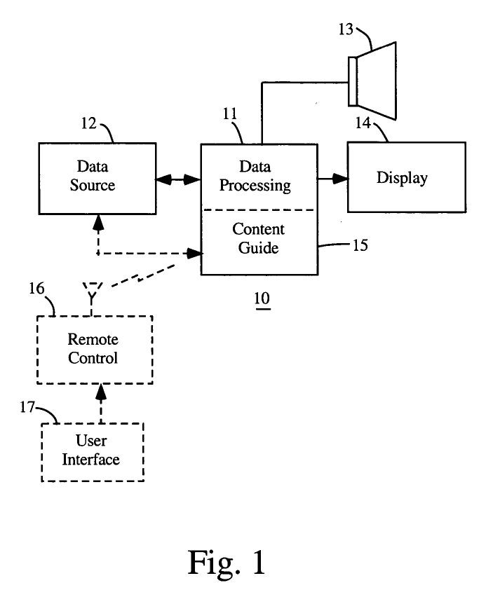

Referring now to the drawings, and in particular to FIG. 1, an apparatus 10 suitable to support and facilitate these teachings can comprise a data processing unit 11 that processes information from a data source 12 (or sources) and provides corresponding audio information to an audio processing path 13 and video information to a display 14.

The control circuitry of the data processing unit 11 can be embodied in a variety of ways. For example, the data processing unit 11 can comprise a fixed-purpose dedicated platform or can comprise a partially or fully programmable platform. Such options and architectural alternatives are well understood in the art and need no further elaboration here. In some embodiments, as with a so-called cable or satellite set-top box, the data processing unit 11 can be readily realized through appropriate programming of the processor as typically accompanies such an apparatus.

The data source 12 can comprise any presently known or hereafter developed data source. In a preferred embodiment the data source 12 provides audio/visual content such as television programs and movies. The data source 12 can provide access to wireless broadcast reception services, cable or optical fiber services, and/or satellite services, to name a few (either alone or in conjunction with one another). Depending upon the needs of the application, it is also possible that the data source 12 provides access to discrete selectable items of audio/visual content as are embodied in a plurality of media. For example, the data source 12 may provide access to cable programming options, satellite programming options, and local programming options as may be available via one or more local or otherwise available media drives (such as but not limited to video tape drives or digital video disk (DVD) drives). It is also possible that the data processing unit 11 operably couples to a plurality of such data sources to permit access to corresponding programming services and viewing options.

In a preferred embodiment this apparatus 10 further comprises a content guide 15. This content guide 15 can comprise an integral part of the data processing unit 11 (as suggested by the illustration in FIG. 1) or can comprise a physically separate platform that operably couples to the data processing unit 11. The content guide 15 can receive information regarding programming options in any of a variety of ways. For example, the data source 12 itself can source such information (either via the data processing unit 11 or directly via a dedicated coupling between itself and the content guide 15 engine). As another example, the content guide 15 can obtain such programming information in other ways such as via a dial-up link (not shown) that facilitates access to a server that provides such information.

In a preferred embodiment the content guide 15 further comprises at least one characterizing descriptor filter. The particular filter used can be selected as appropriate to the given needs and specific requirements of a given application. Some filter examples include, but are not limited to, a genre filter (with filter criteria such as “all,” “children's programming,” “comedy,” “drama,” “documentary,” “favorites list,” “service provider's recommendations,” “audio only,” and the like), a temporal filter (with filter criteria such as “now,” “upcoming within the next hour,” “tomorrow,” “previously recorded,” and the like), or a media/source filter (with filter criteria such as “broadcast television,” “satellite service 2,” “cable service 1,” “Internet content,” “DVD bank 1,” “digital video recorder 3, ” and the like). By use of such a filter, an initial pool of candidate viewing choices can be reduced on the basis of the filter selection criteria as is generally well understood in the art.

Such content guides are generally well understood in the art. The particular configuration and/or general operation of such engines is not especially important to these embodiments. Therefore additional detailed description will not be provided here regarding content guides except where appropriate below with respect to the description of these embodiments.

It will be understood that such apparatus 10 are often at least partially responsive to an optional wireless remote control 16. The latter often use infrared technology to facilitate communications but any wireless technology as may be appropriate to the needs of a given application can be utilized. In many instances such a remote control 16 will include a user interface 17 such as, for example, a keypad. Such a keypad will provide one or more keys that, when asserted by a user, will cause transmission of a particular corresponding wireless instruction by the remote control 16. Pursuant to a preferred embodiment, the operations of the content guide 15 will be at least partially configurable and/or otherwise controllable by appropriate remote control signals. Again, such remote controls are well understood in the art and require no further elaboration here.

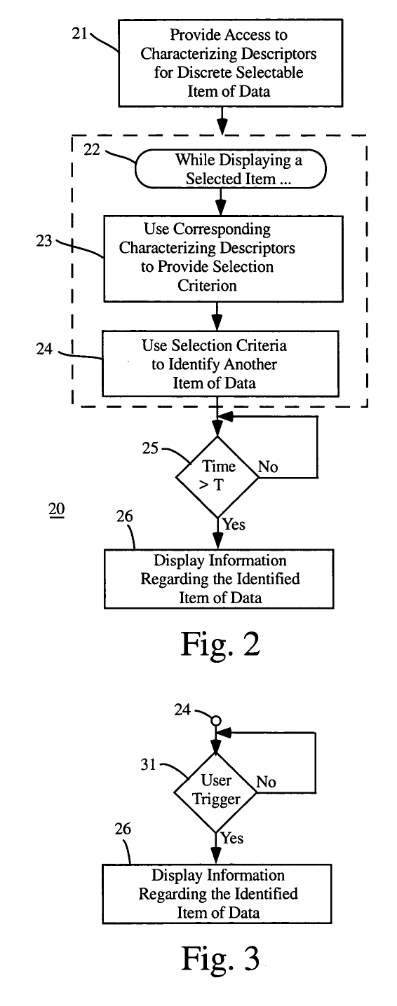

Referring now to FIG. 2, a process 20 that is readily supported by such an apparatus 10 (or that can be alternatively effected through any other suitable architectural configuration of choice) will be described. This process 20 provides for access 21 to characterizing descriptors as individually correspond to a plurality of discrete selectable items of data. In a preferred embodiment these discrete selectable items of data comprise items having audio/visual content (such as individual movies or television programs). The characterizing descriptors for such items of audio/visual content can be many and varied and can include, for example, a programming network identifier (such as the network call sign for a station that will broadcast or otherwise source the particular program), a broadcast starting time (or stopping time) for the program, a description (such as a textual description) of (or that otherwise pertains to) the audio/visual work, and an indication of the content media source itself (such as whether the program is available by cable, satellite, local media, or the like). The characterizing descriptors can also include samples of the video (and/or audio content) of the item itself and/or a previously prepared trailer or other preview or promotional sample for the item.

Then, while presently displaying a given selected item of data 22 (such as a particular television program, movie, or other audio/visual work as obtained from some corresponding source), the process 20 uses 23 one or more characterizing descriptors as correspond to that selected item of data to provide at least one selection criterion. For example, the characterizing descriptors for a given item of data might specify a broadcast source, a textual plot summary, a listing of the key actors in the work, a genre categorization, and so forth as is otherwise well understood in the art. Pursuant to one approach one or more such preselected characterizing descriptors are noted. For example, the genre categorization and nouns appearing in the plot summary might be identified and accessed to then define or otherwise influence the formation of a corresponding selection criterion (or criteria).

That selection criterion (or criteria) is then used 24 as the basis of a filter to employ in conjunction with some predetermined set of candidate programs. Pursuant to one approach this selection criteria can be applied against all potentially available programming options. In a preferred approach, however, this selection criteria will be used in conjunction with some useful subset of all potentially available programming options. In particular, in a preferred approach, the selection criteria will be used to process a subset of programming options that includes only presently available, or soon to be available, programming options. To illustrate, if the presently selected program will conclude at 7:00 PM, then the selection criteria will preferably be applied with respect to only candidate programming options that will begin at or near 7:00 PM.

The process 20 then determines 25 whether a particular time T has occurred. In a preferred embodiment this time T will correspond to the time at which the presently selected program concludes. To illustrate, if the presently selected program is scheduled to conclude at 7:00 PM, then time T will correspond to 7:00 PM (for example, time T may equal 7:00 PM, or five minutes prior to 7:00 PM, or some other time that is determined as a function, at least in part, of 7:00 PM). When the trigger time occurs, the process 20 then automatically displays 26 information regarding the programming options that are the result of the above-described filtering process.

So configured, at a time that is temporally proximal to a conclusion of displaying a presently selected discrete selected item of data, at least one other viewing option will be automatically displayed. This viewing option will relate in some desired way to the program being presently viewed. The viewer will therefore be automatically provided with a short list of viewing options that are akin in some manner to that which the viewer has just finished watching.

The display of such information can be as complete or as sparse as may be desired. For example, only a small amount of available characterizing descriptors for the candidate viewing options may be initially shown, with additional detail being available through use of an appropriate selection capability. This approach will typically allow a number of options to be simultaneously displayed at once on a display while also permitting additional information to be provided upon request. The information itself can also comprise any of textual information, graphic information (such as a graphic image from the video portion of the item), and/or a video sequence from the item or that otherwise relates to the item (such as a corresponding preview or so-called trailer).

The comparison criteria can be fixed or alterable as appropriate to the needs of a given application. When alterable, it may be appropriate to use a default set of comparison criteria while also permitting a user to customize the specific criteria that are used to effect the comparison process. It may also be useful to provide for automated or customizable weighting of such criteria. For example, a given viewer may be more interested in a particular content while another viewer may be more inclined to favor the key actors. The former might benefit from a comparison criteria that weights more heavily a favorable genre comparison while the latter might benefit from a comparison criteria that weights more heavily the inclusion of one or more of the same actors.

In the examples above, the process provides for an automated presentation of the viewing candidate at a time that coincides in some way with the conclusion of a presently viewed program. It may also be useful in some circumstances to also provide (or to substitute for) this approach by allowing a viewer to call up such a list on demand. For example, and referring now to FIG. 3, upon detecting 31 a user trigger (such as a specific corresponding signal as received via a remote control) the same kind of information display can be provided. Such a capability might be permitted at any time following creation of the list or might be limited to only being permitted during a specific window of time (such as within a few minutes of the conclusion of the presently displayed program). It might also be useful in some instances to respond to such a trigger by effecting the evaluation and filtering process described above (in other words, the evaluation and filtering process would not occur automatically but would be conducted in response to a specific request by the viewer for such information).

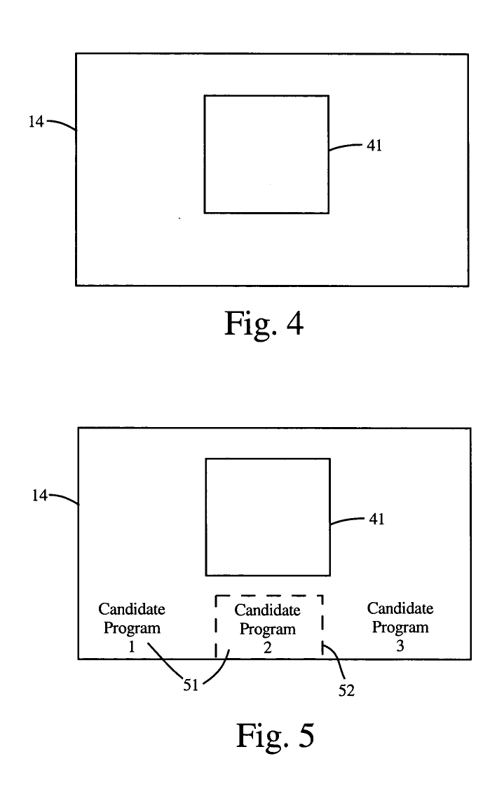

Such a configuration can result in a simple and readily understood interface. With reference to FIG. 4, much of the above processing can occur while only a presently selected program 41 is displayed on the display 14. Then at the appropriate time (and/or in response to a specific request from the viewer), the contents of the resultant short list can be displayed on the display 14 as well. In this illustration, there are three such candidate programs 51 that are presented at the bottom of the display 14. In a preferred embodiment these candidate programs 51 are displayed over the display of a presently selected program 41 such that the latter provides a background image for the former.

An area of focus 52 as is otherwise well understood in the art can then be used to pre-select and consider these candidate programs and to select a desired candidate program for present (or near-term) viewing (or recording or such other action as may be appropriate). If desired, additional informational content can be provided when this area of focus 52 coincides with a given one of the candidate program descriptors. For example, additional textual information can be provided and/or a short visual (or audio or audio/visual) informational presentation can be provided (using the entire display 14 or, for example, an area that corresponds to the display size of the area of focus 52).

Also, and as will be well understood by those skilled in the art, movement/navigation of the area of focus 52 can be used by the viewer to cause additional candidate programs to be displayed when there are too many candidate programs to reasonably display at a single time on the display 14. For example, the area of focus 52 can be moved laterally to eventually reach the edge of the display 14, at which point additional candidate program information can be moved onto the display (using a scrolling technique or by replacing the displayed information in bulk using a page-by-page technique).

It can therefore be seen that a viewer can be provided with a reduced (and likely significantly reduced) set of candidate viewing options at a point in time when the viewer may well be interested in identifying a next program to view. This set of candidate viewing options is determined largely (or solely) as a function and by way of comparison with the very program that the viewer has just completed (or is about to complete) viewing. Little (or no) action on the part of the viewer is required and review and selection of the candidates is highly intuitive and simple to accomplish. Depending upon the degree of interaction that may be supported and/or engaged in by the viewer, this process occurs almost transparently to the viewer.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

1. A method comprising:
providing access to characterizing descriptors as individually correspond to a plurality of discrete selectable items of data;
while displaying a selected discrete selectable item of data:
using the characterizing descriptors as correspond to the selected discrete selectable item of data to provide at least one selection criterion;
using the at least one selection criterion to identify at least another one of the plurality of discrete selectable items of data;
displaying information regarding the at least another one of the plurality of discrete selectable items of data at a time that is temporally proximal to a conclusion of displaying the selected discrete selectable item of data.

2. The method of claim 1 wherein providing access to characterizing descriptors as individually correspond to a plurality of discrete selectable items of data further comprises providing access to textual characterizing descriptors as individually correspond to a plurality of discrete selectable items of data.

3. The method of claim 1 wherein providing access to characterizing descriptors as individually correspond to a plurality of discrete selectable items of data further comprises providing access to characterizing descriptors as individually correspond to a plurality of discrete selectable items of audio/visual content.

4. The method of claim 3 wherein the plurality of discrete selectable items of audio/visual content are embodied in a plurality of media.

5. A method comprising:
providing access to characterizing descriptors as individually correspond to a plurality of discrete selectable items of audio/visual content;
while displaying a selected discrete selectable item of audio/visual content:
identifying at least another one of the plurality of discrete selectable items of audio/visual content for which at least one characterizing descriptor as individually corresponds to the at least another one of the plurality of discrete selectable items of audio/visual content that is similar to a characterizing descriptor of the selected discrete selectable item of audio/visual content;
displaying information regarding the at least another one of the plurality of discrete selectable items of audio/visual content.

6. The method of claim 5 wherein the information regarding the at least another one of the plurality of discrete selectable items of audio/visual content is displayed at a time that is temporally proximal to a conclusion of displaying the selected discrete selectable item of audio/visual content.

7. The method of claim 5 further comprising responding to a remote control device by triggering the display of the information regarding the at least another one of the plurality of discrete selectable items of audio/visual content.

8. The method of claim 5 wherein the information displayed regarding the at least another one of the plurality of discrete selectable items of audio/visual content comprises at least one of:
a graphic image;
a video sequence.

9. The method of claim 5 wherein the plurality of discrete selectable items of audio/visual content are embodied in a plurality of media.

10. An interactive data display system comprising:
characterizing descriptors as individually correspond to a plurality of discrete selectable items of data;
a selected displayed discrete selectable item of data;
control circuitry that:
uses the characterizing descriptors as correspond to the selected displayed discrete selectable item of data to provide at least one selection criterion;
uses the at least one selection criterion to identify at least another one of the plurality of discrete selectable items of data;
displays information regarding the at least another one of the plurality of discrete selectable items of data at a time that is temporally proximal to a conclusion of displaying the selected displayed discrete selectable item of data.

11. The interactive data display system of claim 10 wherein the plurality of discrete selectable items of data comprises a plurality of discrete selectable items of audio/visual content.

12. The interactive data display system of claim 10 further comprising:
a remote control device

13. The interactive data display system of claim 12 wherein the remote control device comprises at least one key to trigger the display of information regarding the at least another one of the plurality of discrete selectable items of data.

14. The interactive data display system of claim 10 wherein the control circuitry further displays information regarding the at least another one of the plurality of discrete selectable items of data at a time that is temporally proximal to a conclusion of displaying the selected discrete selectable item of data.

15. The interactive data display system of claim 11 wherein the information regarding the at least another one of the plurality of discrete selectable items of audio/visual content comprises at least one of:
a graphic image;
a video sequence.
